(19) United States
(12) Patent Application Publication
(10) Pub. No.: US 2004/0081427 A1
(43) Pub. Date: Apr. 29, 2004

(54) Optical recording medium copying apparatus and method therefor

(75) Inventor: Young-Sig Kwon, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/684,514

(22) Filed: Oct. 15, 2003

(30) Foreign Application Priority Data
Oct. 16, 2002 (KR) 02-63273

(51) Int. Cl. H04N 5/76; G11B 5/86; G11B 27/00

(52) U.S. Cl. 386/52; 360/15

(57) ABSTRACT

An optical recording medium copying apparatus and method provides applying power to two compact disc rewritable (CDRW) drives and copying data recorded on a first optical recording medium in one of the CDRW drives to a second optical recording medium in the other CDRW drive, without a PC system or a recording application program. A transmitting optical recording medium drive transmits data recorded on the first optical recording medium when both a predetermined power and a copying signal are applied to the transmitting drive. A receiving optical recording medium drive receives the data from the transmitting drive when both a predetermined power and a copying signal are applied to the receiving drive, and records the received data on the first optical recording medium. Communication lines between the transmitting and receiving drives are used to transmit data recorded on the first optical recording medium to the second optical recording medium.

### CROSS-REFERENCE TO RELATED APPLICATIONS

This application claims the priority benefit of Korean Patent Application No. 2002-63273, filed on Oct. 16, 2002, in the Korean Intellectual Property Office, the disclosure of which is incorporated herein in its entirety by reference.

### BACKGROUND OF THE INVENTION

1. Field of the Invention

The present invention relates to an apparatus and method for copying data onto an optical recording medium, and more particularly, to an optical recording medium copying apparatus and method applying power to two compact disc rewritable (CDRW) drives and copying data recorded on an optical recording medium inserted into one CDRW drive to an optical recording medium inserted into the other CDRW drive, without a PC system or a recording application program.

2. Description of the Related Art

In general, with compact disc rewritable (CDRW) drives, it is possible to copy data, such as audio data, video data, or data of a particular format, which is recorded on a compact disc (CD) to a compact disc recordable (CDR) disc or a CDRW disc. Also, data in a CDR disc can be copied to another CDR disc or a CDRW disc, and data in a CDRW disc can also be copied to another CDRW disc or a CDR disc.

FIG. 1 is a block diagram illustrating the structure of a conventional optical recording medium copying apparatus. Referring to FIG. 1, the apparatus includes a personal computer (PC) 100, a first CDRW drive 101, which is a master drive, and a second CDRW drive which is a slave drive. The PC 100 and a recording application program executing on the PC 100 are necessary for copying data recorded on an optical recording medium in the first CDRW drive 101 to an optical recording medium in the second CDRW drive 102. The original data recorded on an optical medium (disc) inserted into the first CDRW drive 101 is transmitted to the PC 100, as illustrated by \mathring{1} in FIG. 1, while the recording application program is run by the PC 100. Then, the PC 100 converts the original data received from the first CDRW drive 101 into write data and sends the write data to the second CDRW drive 102, as illustrated by \mathring{2} in FIG. 1. The second CDRW drive 102 records the write data sent from the PC 100 to an optical disc (not shown) placed in the second CDRW drive 102.

FIG. 2 is a block diagram illustrating the structure of another conventional optical recording medium copying apparatus. Referring to FIG. 2, the apparatus includes a PC 200 and a CDRW drive 201. The apparatus of FIG. 2 also requires the PC 200 and a recording application program executing on the PC 200 to record the original data recorded on a first optical disc (not shown), which is inserted into the CDRW drive 201, to a second optical disc (not shown), which is also inserted into the CDRW drive 201. The original data recorded on the first optical disc inserted into the CDRW drive 201 is transmitted to the PC 200, as illustrated by \mathring{1} in FIG. 2, while the recording application program is run by the PC 200. Then, the PC 200 converts the original data received from the CDRW drive 201 into write data and sends the write data to the CDRW drive 201, as illustrated by \mathring{2} of FIG. 2. The CDRW drive 201 records the write data sent from the PC 200 to a second optical disc (not shown) placed in the CDRW drive 201.

As shown in FIGS. 1 and 2, conventional optical recording medium copying apparatuses require a PC system and a recording application program executing on the PC system to copy data recorded on an optical disc to another optical disc, using a CDRW drive.

### SUMMARY OF THE INVENTION

The present invention provides an optical recording medium copying apparatus applying power to two compact disc rewritable (CDRW) drives and copying data recorded on an optical recording medium, which is inserted into one of the CDRW drives, to an optical recording medium in the other CDRW drive, without a PC system and a recording application program.

The present invention also provides an optical recording medium copying method in which power is applied to two compact disc rewritable (CDRW) drives and data recorded on an optical recording medium, which is inserted into one of the CDRW drives, is copied to an optical recording medium in the other CDRW drive, without a PC system and a recording application program.

Additional aspects and/or advantages of the invention will be set forth in part in the description which follows and, in part, will be obvious from the description, or may be learned by practice of the invention.

The present invention provides an optical recording medium copying apparatus, comprising a transmitting optical recording medium drive in which an optical recording medium is inserted, which transmits data recorded on the inserted optical recording medium when both a predetermined power and a copying signal are applied to the transmitting optical recording medium drive; a receiving optical recording medium drive in which an optical recording medium is inserted, which receives data from the transmitting optical recording medium drive when both a predetermined power and a copying signal are applied to the receiving optical recording medium drive, and which records the data on the inserted optical recording medium; and communication lines between the transmitting and receiving optical recording medium drives, which are used to transmit the data recorded on the optical recording medium in the transmitting optical recording medium drive to the optical recording medium in the receiving optical recording medium drive.

According to an aspect of the present invention, the communication lines serially transmit the data recorded on the optical recording medium in the transmitting optical recording medium drive to the optical recording medium in the receiving optical recording medium drive.

According to an aspect of the present invention, the transmitting optical recording medium drive includes a disc type determination unit which determines a type of the optical recording medium inserted into the transmitting optical recording medium drive; a disc information decoding unit which decodes data regarding the optical recording medium, the data recorded in a lead-in area of the optical recording medium; a decoding unit which decodes program area data regarding the optical recording medium, the program area data recorded in a program area of the optical recording medium; and a controller which controls transmission of the decoded data from the lead-in area and the decoded program area data from the program area to the receiving optical recording medium drive, controls transmission of a signal to the receiving optical recording medium drive, when a copying key is pressed, the copying key installed outside the transmitting optical recording medium drive,, and controls transmission of a signal indicating a state of the transmitting optical recording medium drive.

According to an aspect of the present invention, the receiving optical recording medium drive comprises a disc type determination unit which determines a type of the optical recording medium on which the data transmitted from the transmitting optical recording medium drive is recorded; a storage unit which stores the data transmitted from the transmitting optical recording medium drive; a signal processor which signal processes and converts the data stored in the storage unit into a recordable signal; and a controller which controls sequential recording of the data in the lead-in area, the program area, and a lead-out area of the optical recording medium, and controls transmission of a confirmation signal indicating a state of the receiving optical recording medium drive to the transmitting optical recording medium drive, when a copying key is pressed, the copying key installed outside the receiving optical recording medium drive.

The present invention may also be achieved by an optical recording medium copying method in an optical recording medium copying apparatus in which a transmitting optical recording medium drive operates when a predetermined power is applied to the drive, and a receiving optical recording medium drive operates when a predetermined power is applied to the drive and transmits data to or receives data from the transmitting optical recording medium drive using a communication line which is different from a communication line used by the transmitting optical recording medium drive. The method comprises determining types of optical recording media when the optical recording media are inserted into the transmitting and receiving optical recording medium drives as a transmitting and receiving optical recording medium, respectively, and a copying signal is input to both these drives; converting data recorded in a lead-in area and program area data recorded in a program area of a transmitting optical recording medium, into data for transmitting, and transmitting the converted data to the receiving optical recording medium drive; and sequentially recording in the receiving optical recording medium drive the data received from the transmitting optical recording medium drive in a lead-in area and a program area of a receiving optical recording medium, respectively, generating in the receiving optical recording medium drive data to be recorded in a lead-out area of the receiving optical recording medium, and recording the generated data in the lead-out area.

According to an aspect of the invention, the data converting comprises decoding the data recorded in the lead-in area of the transmitting optical recording medium; decoding the data recorded in the program area of the transmitting optical recording medium; and transmitting the decoded data from the lead-in area and the program area of the transmitting optical recording medium to the receiving optical recording medium drive.

According to an aspect of the present invention, the sequential data recording comprises generating a sub-code and a sub-Q value for a program memory area (PMA) of the lead-in area of the receiving optical recording medium using the received data, and recording identification of the transmitting optical recording medium, track information, the generated PMA sub-code, and the generated PMA sub-Q value in the PMA of the lead-in area of the receiving optical recording medium; generating a sub-code and a sub-Q value for a TOC area of the lead-in area of the receiving optical recording medium using the received data, and recording TOC information, the generated TOC sub-code, and the generated TOC sub-Q value in the TOC area of the lead-in area of the receiving optical recording medium; generating a sub-code and a sub-Q value for a pre-gap area having predetermined blocks of the receiving optical recording medium using the received data, and recording the generated pre-gap area sub-code and the generated pre-gap area sub-Q value in the pre-gap area of the receiving optical recording medium; detecting the program area data recorded in the program area of the transmitting optical recording medium from the received data and recording the detected program area data in the program area of the receiving optical recording medium; and generating a sub-code and a sub-Q value for a lead-out area of the receiving optical recording medium and recording the generated lead-out area sub-code and the generated lead-out area sub-Q value in the lead-out area of the receiving optical recording medium, after recording the received program area data in the program area of the receiving optical recording medium.

### BRIEF DESCRIPTION OF THE DRAWINGS

The above and/or other aspects and advantages of the invention will become apparent and more readily appreciated from the following description of the embodiments taken in conjunction with the accompanying drawings in which:

FIG. 1 is a block diagram of a conventional optical recording medium copying apparatus;

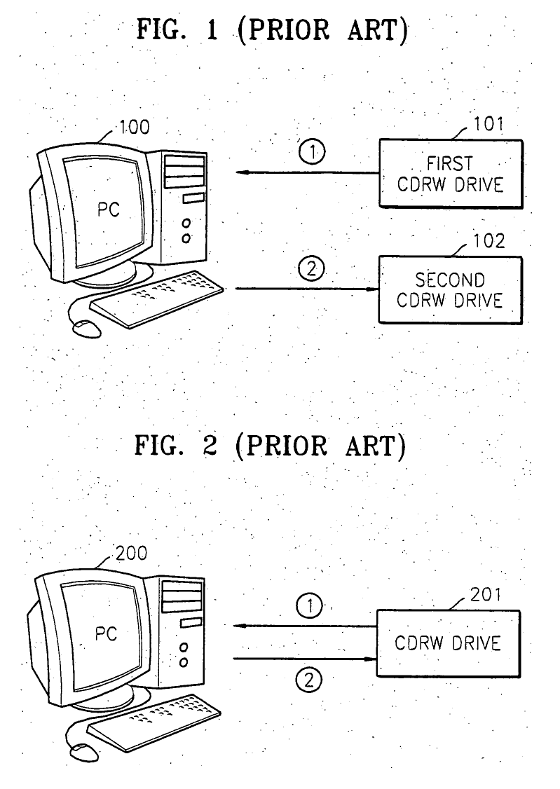

FIG. 2 is a block diagram of another example of a conventional optical recording medium copying apparatus;

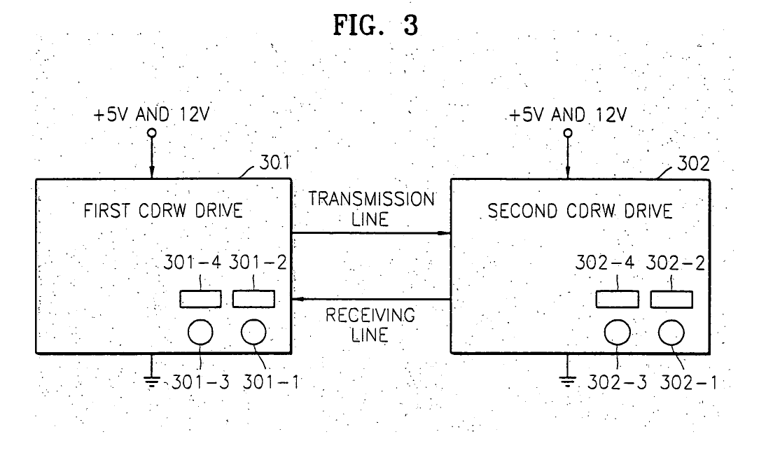

FIG. 3 is a block diagram of an optical recording medium copying apparatus comprising two CDRW drives and communication lines therebetween, according to an embodiment of the present invention;

FIG. 4 is a detailed functional block diagram of the optical recording medium copying apparatus of FIG. 3, according to an embodiment of the present invention;

FIGS. 5A and 5B are flowcharts of copying an optical recording medium, according to an embodiment of the present invention; and

FIG. 6 is a flowchart of operation 513 in FIG. 5B to record data sent from a first CDRW drive to an optical disc in a second CDRW drive, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

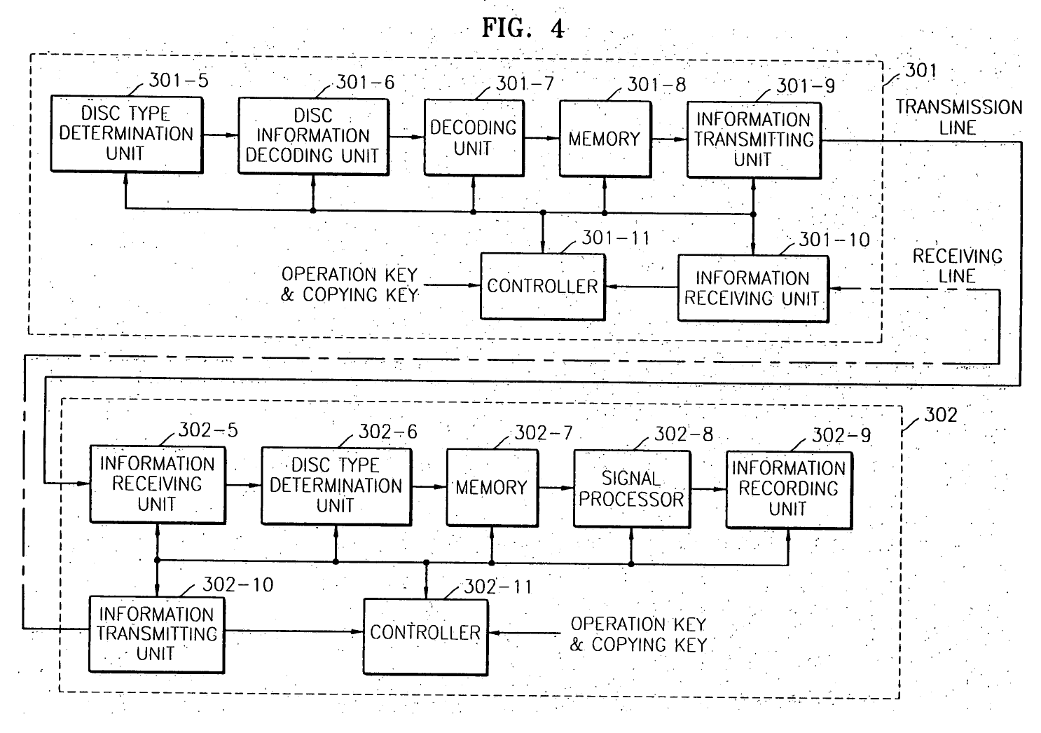

FIG. 3 is a block diagram of an optical recording medium copying apparatus comprising two CDRW drives and communication lines therebetween, according to an embodiment of the present invention. The apparatus of FIG. 3 includes a first compact disc rewritable (CDRW) drive 301 having a first operation key 301-1, a first operation light emitting diode (LED) 301-2, a first copying key 301-3, and a first copying LED 301-4; and a second CDRW drive 302 having a second operation key 302-1, a second operation LED 302-2, a second copying key 302-3; and a second copying LED 302-4. Data is exchanged between the first and second CDRW drives 301 and 302 via the transmission and receiving communication lines between the first and second CDRW drives. Typically, the transmission and receiving communication lines are serial communication lines.

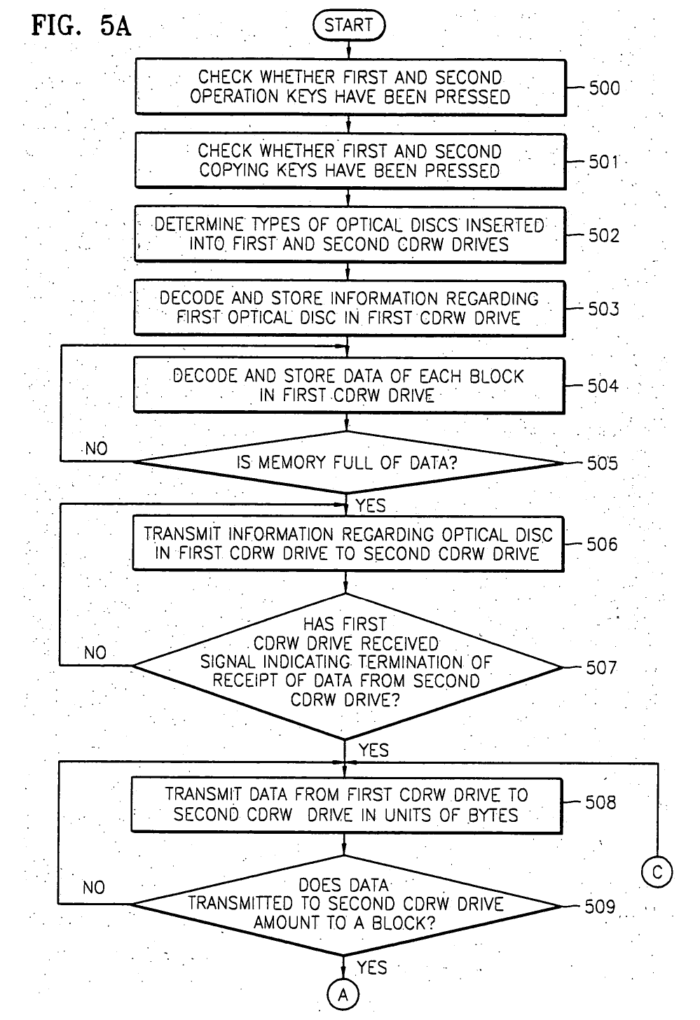

FIG. 4 is a detailed functional block diagram of the optical recording medium copying apparatus of FIG. 3, according to an embodiment of the present invention. The first CDRW drive 301 includes a disc type determination unit 301-5, a disc information decoding unit 301-6, a decoding unit 301-7, a memory 301-8, an information transmitting unit 301-9, an information receiving unit 301-10, and a controller 301-11. The second CDRW drive 302 includes an information receiving unit 302-5, a disc type determination unit 302-6, a memory 302-7, a signal processor 302-8, an information recording unit 302-9, an information transmitting unit 302-10, and a controller 302-11.

The optical recording medium copying apparatus according to the first embodiment of the present invention will now be described in a greater detail with reference to FIGS. 3 and 4. A transmission line and a receiving line are installed to exchange data between the first and second CDRW drives 301 and 302. Typically, the data exchanging transmission line and the receiving line are serial communication lines. More specifically, the transmission line serially transmits a certain amount of data and the receiving line serially receives the certain amount of data. The first CDRW drive 301 transmits data to the second CDRW drive 302 via the transmission line and the second CDRW drive 302 can inform the first CDRW drive 301 as to whether the transmitted data is completely received. During the transmission of data, the first CDRW drive 301 can check a state of the second CDRW drive 302, i.e., whether the second CDRW drive 302 is performing a recording operation, whether a capacity of a memory of the second CDRW drive 302 is sufficient, or whether an error has occurred in the second CDRW drive 302.

The first CDRW drive 301 operates by handling (e.g., pressing) the first operation key 301-1 and the first copying key 301-3 and the second CDRW drive 302 operates by handling (e.g., pressing) the second operation key 302-1 and the second copying key 302-3. More particularly, typically, the keys of the first and second CDRW drives 301 and 302 are handled in the order of the second operation key 302-1, the first operation key 301-1, the first copying key 301-3, and the second copying key 302-3.

More specifically, power is applied to the first and second CDRW drives 301 and 302, and then the second operation key 302-1 of the second CDRW drive 302 is pressed to turn on the second operation LED 302-2. Typically, the second operation LED 302-2 is originally white and changes to green when the second CDRW drive 302 is ready for receiving data from the first CDRW drive 301. However, typically, the second operation LED 302-2 is red while the second CDRW drive 302 prepares to receive the data from the first CDRW drive 301. If the second operation LED 302-2 turns green, the first operation key 301-1 of the first CDRW drive 301 can be pressed to turn on the first operation LED 301-2. Typically, the first operation LED 301-2 is also white. However, typically, if the first CDRW drive 301 is ready to transmit the data to the second CDRW drive 302, the first operation LED 301-2 also changes to green. Also, typically, the first operation LED 301-2 becomes red while the first CDRW drive 301 makes preparation for transmitting the data to the second CDRW drive 302.

If the first operation LED 301-2 of the first CDRW drive 301 and the second operation LED 302-2 of the second CDRW drive 302 are both green, the first copying key 301-3 of the first CDRW drive 302 can be pressed. Then, the first copying LED 301-4, which, typically, is originally white, changes, typically, to green and the first CDRW drive 301 transmits the data to the second CDRW drive 302. When transmission of the data to the second CDRW drive 302 is completed, the first copying LED 301-4, which is in green, becomes white. Also, when the first operation LED 301-2 of the first CDRW drive 301 and the second operation LED 302-2 of the second CDRW drive 302 are both green, the second copying key 302-2 of the second CDRW drive 302 can be pressed. In this case, the second copying LED 302-4, which, typically, is white, changes, typically, to green and the second CDRW drive 302 waits to be supplied with data from the first CDRW drive 301. The second copying LED 302-4 changes, typically, from green to red and remains red while the data is being transmitted to the second CDRW drive 302 from the first CDRW drive 301. After the transmission of data to the second CDRW drive 302, the second copying LED 302-4 changes from red to green.

Next, the first CDRW drive 301, which is a transmission drive, will be described in more detail with reference to FIG. 4. Let us assume that power is applied to the first CDRW drive 301 and the first CDRW drive 301 begins operating when the first operation key 301-1 is pressed. The disc type determination unit 301-5 checks a type of a first optical disc (not shown), which is the original disc, inserted into the first CDRW drive 301. A second optical disc (not shown), which is the copy disc, is inserted into the second CDRW drive 302. In detail, in the first CDRW drive 301, the disc type determination unit 301-5 checks whether the first optical disc is an optical disc, containing audio data, video data, or data of a particular format; or a compact disc recordable (CDR), or a CDRW containing audio data, video data, or data of a particular format. In addition, the disc type determination unit 301-5 checks whether the first optical disc is a variable or a fixed packet disc.

The disc information decoding unit 301-6 decodes information regarding the first optical disc (i.e., decodes the disc related information), the information recorded in a lead-in area of the first optical disc inserted into the first CDRW drive 301. The decoded information is stored in the memory 301-8. The disc information decoding unit 301-6 selects a method of decoding the information regarding the first optical disc, based on the type of the first optical disc determined by the disc type determination unit 301-5. For example, if the first optical disc is a stamp disc (i.e., a read only optical disc, such as a CD, a CD-ROM, DVD, etc.), the disc information decoding unit 301-6 seeks a table of contents (TOC) area, decodes the TOC information from the TOC area, and stores the decoded disc TOC information in a certain region of the memory 301-8. If, for example, the first optical disc is a CDR or a CDRW, the disc information decoding unit 301-6 seeks a program memory area (PMA), and from PMA data recorded in the PMA decodes information used to identify the disc, and starting and ending points of the disc, and stores the decoded PMA information in a certain region of the memory 301-8. Further, the disc information decoding unit 301-6 checks from the information regarding the first optical disc (i.e., from the disc related data) whether the program area data is recorded in units of tracks, in units of sessions, or a session in units of discs. The checking result as first optical disc related data is sent, via the controller 301 -11 and the information transmitting unit 301-9, to the second CDRW drive 302. Further, the disc related information transmitted to the second CDRW drive 302 comprises all types of disc related information, including the disc type information, such as a variable or a fixed packet disc type, detected by the disc type determination unit 301-5. The second CDRW drive 302 uses the first optical disc related data to record information regarding a pre-gap area and a link block between adjacent tracks in the second optical disc inserted into the second CDRW drive 302.

The decoding unit 301-7 decodes program area data, which is recorded in a program area of the first optical disc, in units of blocks. The decoded program area data is stored in the memory 301-8. When audio data is recorded on the first optical disc, the decoding unit 301-7 decodes the program area audio data recorded in the program area of the first optical disc and sequentially stores a sub-code and a sub-Q value of the decoded audio data in the memory 301-8. If the optical disc contains video data, the decoding unit 301-7 decodes program area video data recorded in the program area of the optical disc and checks whether an error has occurred in a decoded block. The decoding unit 301-7 decodes the program area video data again when an error has occurred in the decoded block, and sequentially stores decoded video data in the memory 301-8 when no error occurs. If the first optical disc contains data of a particular format, the decoding unit 301-7 decodes program area data recorded in the program area of the first optical disc and checks for occurrence of errors in a decoded block. When an error occurs in the decoded block, the decoding unit 301-7 decodes the program area data again, and when no error occurs, the decoding unit 301-7 sequentially stores the decoded particular format data in the memory 301-8. Also, if the first optical disc is a CDR or a CDRW, the decoding unit 301-7 performs the aforementioned program area data decoding operations in response to a signal output from the disc type determination unit 301-5 which indicates whether the first optical disc is a CDR or CDRW disc containing audio or video data or data of a particular format.

The memory 301-8 receives the information regarding the first optical disc from the disc information decoding unit 301-6 and stores the received disc related information in a particular region of itself. Also, the program area data, which is recorded in the program area of the first optical disc and then decoded by the decoding unit 30-7, is sequentially stored in a region other than the particular region storing the disc related information. The controller 301-11 checks a capacity of the memory 301-8 and controls the storage operation of the memory 301-8. More specifically, when the memory 301-8 is full of data, the controller 301-11 controls the memory 301-8 to discontinue storing data, and when the memory is not full of data, the controller 301-11 controls the memory 301-8 to continue storing data.

The information transmitting unit 301-9 transmits data stored in the memory 301-8 to the second CDRW drive 301 under the control of the controller 301-11. Typically, the first copying key 301-4 is pressed to transmit the data stored in the memory 301-8 to the second CDRW drive 302. The controller 301-11 controls the information transmitting unit 301-9 to transmit the decoded disc information regarding the first optical disc before transmission of the decoded program area data in the program area of the first optical disc. The information receiving unit 301-10 receives a signal from the second CDRW drive 302 confirming receipt of the information regarding the first optical disc by the second CDRW drive 302. The CDRW drive 302 decodes the disc related information received from the first CDRW drive 301. If the information receiving unit 301-10 does not receive the confirmation signal after a predetermined time has elapsed, the controller 301-11 controls the information transmitting unit 301-09 to resend the decoded information regarding the first optical disc to the second CDRW drive 302. Upon receiving a confirmation signal from the second CDRW drive 302, the information transmitting unit 301-9 transmits the program area data recorded in the program area of the first optical disc, which is decoded under the control of the controller 301-11, to the second CDRW drive 302. In this case, the controller 301-11 controls transmission of the decoded program area data, which is recorded in the program area of the first optical disc program, in units of bytes. When the information transmitting unit 301-9 transmits the decoded program area data in units of bytes to the second CDRW drive 302, and as a result, a block data of about 3600 bytes is sent to the second CDRW drive 302, the information receiving unit 301-10 waits to receive a signal which confirms receipt of the block data from the second CDRW drive 302. When transmission of all the data blocks stored in the memory 301-8 to the second CDRW drive 302 is complete, the controller 301-11 sends a confirmation signal indicating termination of transmission to the second CDRW drive 302 via the information transmitting unit 301-9.

The second CDRW drive 302, which is a receiving drive, will now be described with reference to FIGS. 3 and 4. Let us assume that power is applied to the second CDRW drive 302 and the second CDRW drive 302 begins operating in response to external operation of the second operation key 302-1. The disc type determination unit 302-6 checks a type of the second optical disc (not shown) inserted into the second CDRW drive 302. That is, the disc type determination unit 302-6 checks whether the second CDRW drive is a CDR or a CDRW. If the checking result reveals that the second optical disc is neither a CDR nor a CDRW, a tray (not shown) on which the second optical disc is mounted is opened to inform a user that data cannot be copied to the second optical disc. In other words, when the second optical disc is a stamp disc (i.e., a read only optical disc) containing audio/video data or data of a particular format, the disc type determination unit 302-6 opens the tray to let the user know that data cannot be copied to the second CDRW drive 302. If the second optical disc is an unused blank CDR or CDRW disc, or a used CDRW disc from which data has been erased, the disc type determination unit 302-6 prepares the second optical disc so that data can be written thereto.

When the user presses the second copying key 302-3, the information receiving unit 302-5 receives data transmitted from the first CDRW drive 301. The information receiving unit 302-5 first receives decoded information regarding the first optical disc (i.e., receives disc related information) and then receives decoded data regarding a program area (i.e., receives program area data). Upon completing the receipt of the decoded first optical disc information, the information receiving unit 302-5 sends a signal, which indicates the receipt of the disc related information, to the first CDRW drive 301 via the information transmitting unit 302-10 under the control of the controller 302-11.

The memory 302-7 stores the data transmitted from the information receiving unit 302-5. In detail, the memory 302-7 sequentially stores the decoded first optical disc information in a particular region of the memory 302-7 and the decoded program area data in a region other than the particular region storing the disc related information. The controller 301-11 checks the capacity of the memory 302-7 and transmits a transmission standby signal to the first CDRW drive 301 when the memory 302-7 is full of data. If the controller 302-11 determines that a certain amount of data is stored in the memory 302-7, a recording operation can be started. For example, if more than half the capacity of the memory 302-7 is occupied by data, the controller 302-11 can start recording on the second optical disc.

The signal processor 302-8 produces signals suitable for recording on the second optical disc using the data stored in the memory 302-7 and the information recording unit 302-9 records the produced signals on the second optical disc. More specifically, the signal processor 302-8 produces signals using the decoded first optical disc information and generates a sub-code and a sub-Q value of a PMA for the second optical disc. The PMA of the second optical disc, which can be CDR or a CDRW, corresponds to an area which is left when 1000 blocks are excluded from the beginning of a lead-in area of the second optical disc. The information recording unit 302-9 records disc related information, such as disc identification, track information, the generated sub code, and the generated sub-Q value, in the PMA of the second optical disc. The signal processor 302-8 generates a sub-code and a sub-Q value for a TOC area. The information recording unit 302-9 records TOC information, and the generated sub-code and sub-Q value for the TOC area on an area between the beginning of the lead-in area and 0 minutes, 0 seconds, 0^{th} frame, i.e., the TOC area, of the second optical disc. The signal processor 302-8 also generates a sub-code and a sub-Q value for a pre-gap area, and the information recording unit 302-9 records the generated sub-code and sub-Q value on 150 blocks from the beginning of the lead-in area of the second optical disc, i.e., the pre-gap area, between 0 minutes, 0 seconds, 0^{th} frame and 0 minutes, 2 seconds, 0^{th} frame. The signal processor 302-8 encodes and records a data block based upon program area data recording information in the disc related information transmitted from the first CDRW drive 301, such as program area data recording in units of tracks, sessions, discs, and variable and fixed packets. After finishing recording to the pre-gap area, the signal processor 302-8 processes the received program area data as signals and the information recording unit 302-9 records the program area data, which is signal-processed, on the second optical disc in the second CDRW drive 302.

When the information receiving unit 302-5 receives from the first CDRW drive 301 a confirmation signal indicating the termination of data transmission, the controller 302-11 controls the signal processor 302-8 to generate a sub-code and a sub-Q value for a lead-out area, which is an ending portion of the second optical disc. The information recording unit 302-9 records the sub-code and the sub-Q value for the lead-out area, which are generated by the signal processor 302-8, on the optical disc in the second CDRW drive 302. Upon finishing recording operations to the lead-out area, the controller 302-11 controls the information transmitting unit 302-10 to transmit to the first CDRW drive 301 a confirmation signal indicating the termination of copying data. Typically, when the first CDRW drive 301 receives the copy termination signal from the CDRW 302, the second optical disc tray is opened.

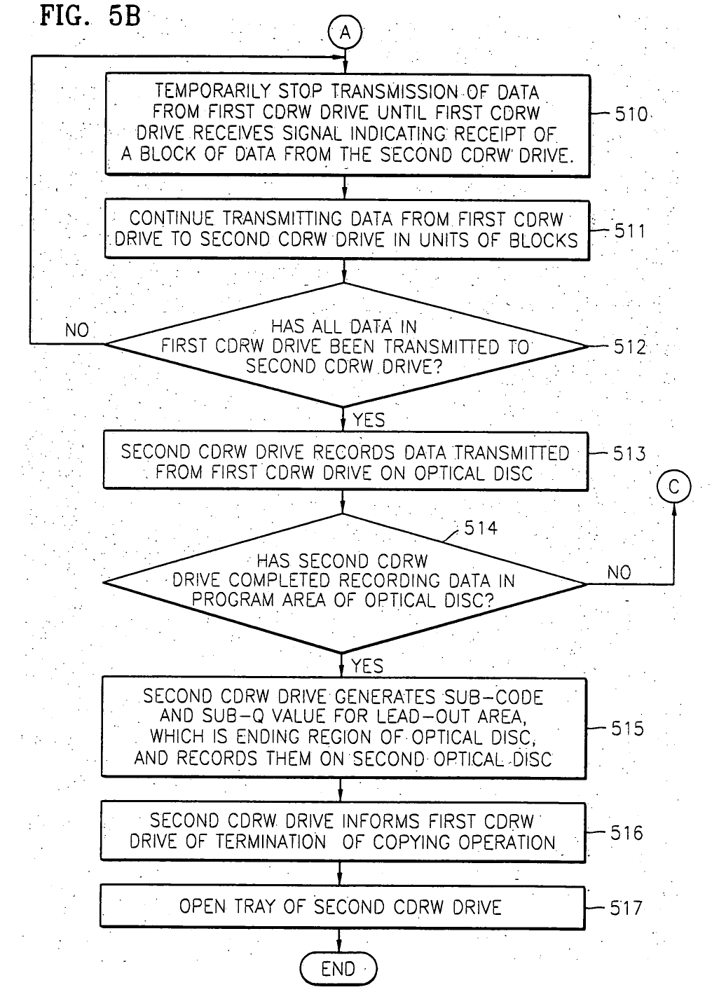

FIGS. 5A and 5B are flowcharts of an optical recording medium copying method according to an embodiment of the present invention. Referring to FIGS. 5A and 5B, the optical recording medium copying comprises checking, at operation 500, whether first and second operation keys 301-1 and 302-1 have been pressed; checking, at operation 501, whether first and second copying keys 301-3 and 302-3 have been pressed; checking, at operation 502, the types of first and second optical discs which are inserted into first and second CDRW drives, respectively; decoding and storing, at operation 503, information regarding the first optical disc in the first CDRW drive; decoding and storing, at operation 504, data (i.e., program area data) in the first CDRW drive; and checking, at operation 505, whether a first CDRW memory is full of data. If determined, at operation 505, that the first CDRW memory is full, transmitting, at operation 506, the first optical disc information to the second CDRW drive; and checking, at operation 507, whether a confirmation signal indicating the termination of receipt of the first optical disc information is transmitted from the second CDRW drive to the first CDRW drive. If determined, at operation 507, that the confirmation signal confirming receipt of the disc related information by the second CDRW drive is received, transmitting, at operation 508, the program area data from the first CDRW drive in units of bytes to the second CDRW drive; and checking, at operation 509, whether a total of data transmitted to the second CDRW drive amounts to a block. If determined, at operation 509, that the total transmitted data is a block, temporarily, at operation 510, stopping the transmission of data from the first CDRW until the first CDRW drive receives a confirmation signal indicating the completion of receipt of a block of data from the second CDRW drive.

At operation 512, it is determined whether all of the program area data in the first CDRW drive has been transmitted to the second CDRW drive and if all of the program area data has not been transmitted from the first CDRW drive to the second CDRW drive, the copying process returns to operation 510. More particularly, in operations 510 through 512, the first CDRW drive continuously transmits the program area data of the first optical disc to the second CDRW drive in units of blocks until the program area data of the first optical disc is completely sent to the second CDRW drive. At operation 513, the second CDRW drive records the program area data, which is transmitted from the first CDRW drive, on the second optical disc. At operation 514, it is determined whether the second CDRW drive has finished recording the received program area data on a program area of the second optical disc. If determined, at operation 514, that the second CDRW drive has not completed recording the first optical disc program area data in the program area of the second optical disc, the copying process returns to operation 508 to continue the first optical disc program area data transmission and the second optical disc program area data reception (i.e., in case the first optical disc program area data is recorded in units of discs). If determined, at operation 514, that the second CDRW drive has completed recording the first optical disc program area data on the second optical disc, at operation 515, the second CDRW drive generates a sub-code and generates a sub-Q value for a lead-out area of the second optical disc, which is an ending region of the second optical disc, and records the generated sub-code and sub-Q value on the second optical disc. At operation 516, the second CDRW drive informs the first CDRW drive of termination of data copying to the second optical disc. Typically, at operation 517, the second CDRW drive opens the second optical disc tray.

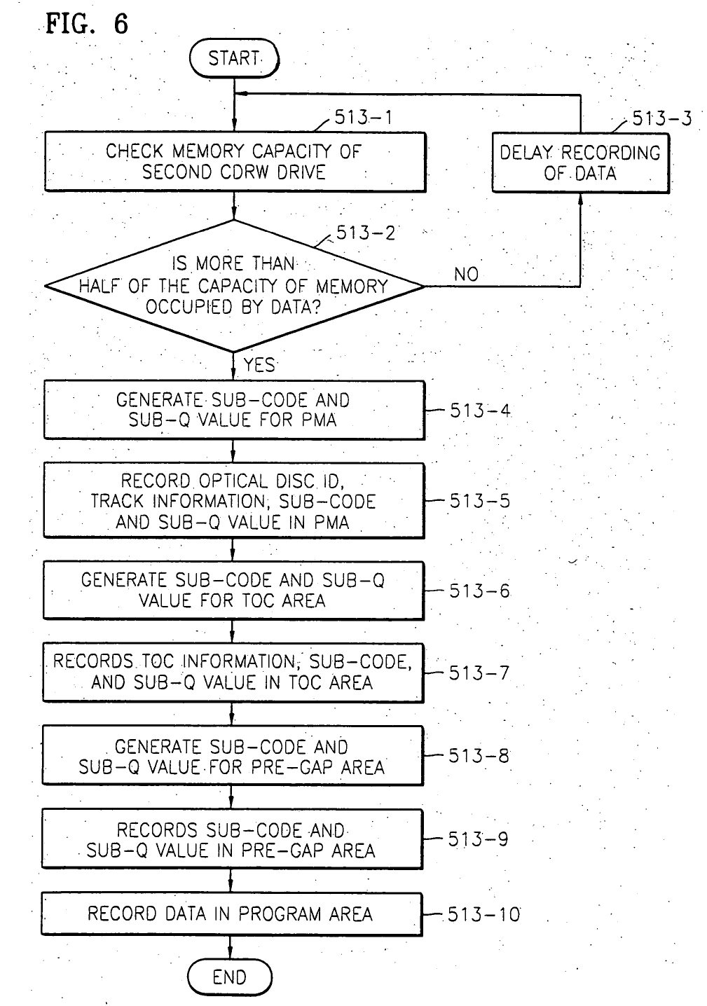

FIG. 6 is a flowchart of operation 513 in FIG. 5B to record data sent from a first CDRW drive on an optical disc in a second CDRW drive. Referring to FIG. 6, the data recording on the second optical disc comprises checking, at operation 513-1, the memory capacity of the second CDRW drive; and checking, at operation 513-2, whether half of the capacity of the memory is occupied by data. If determined, at operation 513-2, that more than half of the memory capacity is not full of data, delaying, at operation 513-3, the data recording. If determined, at operation 513-2, that more than half of the memory is full of data, generating, at operation 513-4 a sub-code and a sub-Q value for a PMA of the second optical disc. At operation 513-5, the identification of the second optical disc, information regarding tracks, the generated sub-code, and the generated sub-Q value are recorded in the second optical disc PMA. At operation 513-6, a sub-code and a sub-Q value for a TOC area of the second optical disc are generated, and, at operation 513-7, TOC information, and the generated sub-code and sub-Q value for the TOC area are recoded in the second optical disc TOC area. At operation 513-8, a sub-code and a sub-Q value for a pre-gap area of the second optical disc are generated, and, at operation 513-9, the generated sub-code and sub-Q value are recorded in the pre-gap area. At operation 513-10, the received program area data is recorded in a program area of the second optical disc.

Hereinafter, an optical recording medium copying method will be described in greater detail with reference to FIGS. 3 through 6. First, at operation 500, the first and second CDRW drives 301 and 302 check whether the first and second operation keys 301-1 and 302-1 have been pressed. More specifically, in operation 500, power is applied to the first and second CDRW drives and the second operation key 302-1 of the second CDRW drive 302 is pressed to turn on the second operation LED 302-2. When the second CDRW drive 302 is ready for receipt of data from the first CDRW drive 301, the second operation LED 302-2, which is initially white, changes into green. While the second CDRW drive 302 prepares to receive data, the second operation LED 302-2 is green. If the second operation LED 302-2 of the second CDRW drive 302 is green, the first operation key 301-1 of the first CDRW drive 301 is pressed to turn on the first operation LED 301-2. When the first CDRW drive 301 is ready for transmission of data to the second CDRW drive 302, the first operation LED 301-2, which is initially white, changes to green. However, while the first CDRW drive 301 prepares to transmit the data, the first operation LED 301-2 is red.

If, at operation 500, the pressing of the first and second operation keys 301-1 and 302-1 is confirmed, at operation 501, the first and second CDRW drives 301 and 302 check whether the first and second copying keys 301-3 and 302-3 are pressed. In detail, the first operation LED 301-2 of the first CDRW drive 301 and the second operation LED 302-2 of the second CDRW drive 302 change to green, and then, the first copying key 301-3 of the first CDRW drive is pressed. As a result, the first copying LED 301-4, which is initially white, changes to green, and then, the first CDRW drive 301 sends data to the second CDRW drive 302. After the first CDRW drive 301 finishes sending data to the second CDRW drive 302, the first copying LED 301-4, which is green, becomes white. Also, when the first operation LED 301-2 and the second operation LED 302-2 change to green, the second copying key 302-3 of the second CDRW drive 302 is pressed to change the second copying LED 302-4, which is initially white, to green and to prepare the second CDRW drive 302 for receipt of data from the first CDRW drive 301. While the second CDRW drive is preparing to receive the data from the first CDRW drive 301, the second copying LED 302-4 changes from green to red. After the second CDRW drive 302 completes receiving data from the first CDRW drive 301, the second copying LED 302-4, which is red, becomes white.

If determined in operation 501, that the first and second copying keys 301-3 and 302-3 have been pressed, at operation 502, the types of the first and second optical discs, which are inserted into the first and second CDRW drives 301 and 302, respectively, are checked. In detail, the disc type determination unit 301-5 of the first CDRW drive 301 checks whether the first optical disc is a stamp, CDR, or CDRW optical disc containing audio data, video data, or data of a particular format. The disc type determination unit 301-5 also checks whether the first optical disc is a variable or fixed packet disc. The disc type determination unit 302-6 of the second CDRW drive 301 also checks whether the second optical disc is a stamp, CDR, or CDRW optical disc. If the disc type determination unit 302-6 of the second CDRW drive 302 determines that the second optical disc is neither a CDR nor a CDRW, the second optical disc tray (not shown) is opened to inform a user that data cannot be copied to the second optical disc. For example, if the second optical disc is a stamp disc (i.e., a read only optical disc, such as a CD, a CD-ROM, a DVD, etc.) in which audio, video data, or data of a particular format is recorded, the disc type determination unit 302-6 opens the second optical disc tray to inform the user that data cannot be copied to the second optical disc. If the second optical disc is an unused blank CDR or a used CDRW from which data has been erased, the disc type determination unit 302-6 prepares the second optical disc so that data can be recorded thereon.

After detecting, at operation 502, the types of the first and second optical discs, at operation 503, information regarding the first optical disc inserted into the first CDRW drive 301 is decoded and stored in the memory 301-8. More specifically, the disc information decoding unit 301-6 of the first CDRW drive 301 decodes information regarding the first optical disc, the information recorded in a lead-in area of the first optical disc inserted into the first CDRW drive 301. The decoded disc related information is stored in a particular region of the memory 301-8. The disc information decoding unit 301-6 selects a method of decoding the information, based on the type of the first optical disc determined by the disc type determination unit 301-5. For instance, if the first optical disc is a stamp disc, the disc information decoding unit 301-6 seeks a TOC area, decodes the first optical disc information from the TOC area, and stores the decoded information in a particular area of the memory 301-8. If the first optical disc is a CDR or a CDRW, the disc information decoding unit 301-6 seeks a PMA, decodes information to identify the disc and information regarding starting and ending positions of the disc from the PMA, and stores the decoded information in a particular region of the memory 301-8. Also, the disc information decoding unit 301-6 checks the information regarding the first optical disc (i.e., from the disc related information) whether the program area data on the first optical disc is recorded in units of tracks, units of sessions, or units of discs. The checking result as first optical disc related data, including the disc type determination information detected by the disc type determination unit 301-5, is transmitted to the second CDRW drive 302 and the second CDRW drive 302 uses the first optical disc related data in recording information regarding a link block between a pre-gap area and each track on the second optical disc.

After decoding and storing, at operation 503, the first optical disc information, at operation 504, program area data is decoded and stored on a block-by-block basis in the first CDRW drive 301. In detail, the decoding unit 301-7 of the first CDRW drive 301 decodes data recorded in a program area of the first optical disc on a block-by-block basis and stores the decoding program area data in the memory 301-8. If the first optical disc contains audio data, the decoding unit 301-7 decodes the program area data recorded in the program area of the first optical disc and sequentially records a sub-code and a sub-Q value for the decoded audio data in the memory 301-8. If the first optical disc contains video data, the decoding unit 301-7 decodes the program area data in the program area of the first optical disc and checks whether an error occurs in a decoded block. The decoding unit 301-7 performs decoding operations again when an error occurs in the decoded block, and sequentially stores the decoded data in the memory 301-8 when an error does not occur in the decoded block. If the first optical disc contains data of a particular format, the decoding unit 301-7 decodes the data in the program area of the first optical disc and checks whether an error occurs in a decoded block. The decoding unit 301-7 performs decoding operations again when an error occurs in the decoded block, and sequentially stores the decoded data in the memory 301-8 when an error does not occur in the decoded block. Further, when the first optical disc is a CDR or a CDRW, the decoding unit 301-7 performs the aforementioned program area data decoding operations in response to a signal output from the disc type determination unit 301-5 which indicates whether the first optical disc is a CDR or CDRW disc containing audio or video data or data of a particular format.

After operation 504, the capacity of the memory 301-8 of the first CDRW drive 301 is checked, and if the memory 301-8 is full, at operation 506, the first optical disc information, i.e., lead-in area information or disc related information, stored in the memory 301-8 is transmitted to the second CDRW drive 302. At operation 507, the first CDRW drive 301 checks if the first optical disc information has been received by the second CDRW drive 302. In operation 508, when the first CDRW drive 301 receives from the second CDRW drive 301 a confirmation signal indicating the termination of receipt of the first optical disc information, the first CDRW drive 301 transmits the decoded and stored program area data to the second CDRW drive 302 in units of bytes. In operations 509 and 510, when the transmitted decoded program area data, which is transmitted in units of bytes, amounts to a block, i.e., about 3600 bytes, the first CDRW drive 301 waits to receive from the second CDRW drive 302 a confirmation signal indicating receipt of a data block.

Next, in operations 511 and 512, the program area data stored in the memory 301-8 of the first CDRW drive 301 is continuously transmitted in units of blocks, and it is checked whether all the program area data in the memory 301-8 has been transmitted to the second CDRW drive 302. If determined in operation 512 that all data in the first CDRW drive 301 has been transmitted to the second CDRW drive 302, in operation 513, the first CDRW drive 301 sends a confirmation signal indicating the completion of the program area data transmission to the second CDRW drive 302 and the second CDRW drive 302 can begin recording the received program area data on the second optical disc.

More specifically, the second CDRW drive 302 stores the received program area data in the memory 302-7. Then, in operation 513-1, the capacity of the memory 302-7 of the second CDRW drive 302 is checked. When determined in operation 513-2 that more than half of the capacity of the memory 301-7 is occupied by data, at operations 513-4 through 513-10, the controller 302-11 controls recording operations via the signal processor 302-8 and the information recording unit 302-9 on the second optical disc. However, in operation 513-3, if less than half of the capacity of the memory 301-7 is occupied by data, the recording operation is placed in a standby state.

In particular, the signal processor 302-8 and the information recording unit 302-9 control the copying processes 513-4 through 513-10. If determined in operation 513-2 that more than half of the capacity of the memory 301-7 is occupied by data, in operation 513-4, a sub-code and a sub-Q value for a PMA of the second optical disc are generated by the signal processor 302-8. The PMA is an area of the second optical disc, which can be a CDR or a CDRW, that is left when 1000 blocks are subtracted from the beginning of the lead-in area of the second optical disc. Then, in operation 513-5, the identification of the second optical disc, the track information, the generated sub-code, and the generated sub-Q value are recorded in the PMA of the second optical disc by the information recording unit 302-9. Then, in operation 513-6, a sub-code and a sub-Q value for a TOC area are generated. Then, in operation 513-7, TOC information, and the generated sub-code and sub-Q value are recorded between the beginning of the lead-in area of the second optical disc and 0 minutes, 0 seconds, 0^{th} frame, i.e., the TOC area, of the second optical disc. Then, in operation 513-8, a sub-code and a sub-Q value for a pre-gap area are generated. Then, in operation 513-9, the generated sub-code and the generated sub-Q value are recorded on 150 blocks from the beginning of the lead-in area of the second optical disc, i.e., the pre-gap area, between 0 minutes, 0 seconds, 0^{th} frame, and 0 minutes, 2 seconds, 0^{th} frame of the second optical disc. Data blocks are encoded and recorded on the second optical disc differently based on program area data recording information in the disc related information transmitted from the first CDRW drive 301, such as program area data recording in units of tracks, sessions, discs, and variable and fixed packets. After completing recording the generated sub-code and the generated sub-Q value in the pre-gap area, the received program area data is processed by the signal processor 302-8 and recorded by the information recording unit 302-9 in a program area of the second optical disc in operation 513-10.

After operation 513, the second CDRW drive 302 checks, at operation 514, whether the recording of the program area data from the first optical disc in the program area of the second optical disc is complete. If determined, at operation 514, that the program area data recording is complete, in operation 515, the second CDRW drive 302 generates a sub-code and a sub-Q value for a lead-out area of the second optical disc, which is an ending region of the second optical disc, and records the generated lead-out sub-code and sub-Q value on the second optical disc. When, at operation 515, the recording in the lead-out area is finished, at operation 516, the second CDRW drive 302 informs the first CDRW drive 301 of termination of the data copying. Typically, at operation 517, the second optical disc tray of the second CDRW drive 302 is opened. The processes of the present invention as embodied in the FIG. 4 functional blocks are implemented in software and/or computing hardware, providing a stand-alone optical recording medium copying device that can copy any type of optical recording media onto any type of recordable optical recording media without an application program or an interface to a computer.

As described above, according to the present invention, it is possible to copy data contained in an optical recording medium inserted into a CDRW drive to an optical recording medium inserted into another CDRW drive, without a PC system and an application recording program. Although as an example the above-described embodiment is an optical recording medium copying device comprising a pair of CDRW drives for copying data from a CD, CDR or CDRW to a CDR or CDRW, the present invention is not limited to such a configuration and the optical recording medium copying device can comprise a pair of drives to copy data from any type of optical recording medium to any type of recordable optical recording medium. In particular, the present invention provides an optical recording medium copying device, comprising a transmitting optical disc drive having a first copying button and transmitting data recorded on any optical recording disc type (e.g., CD, CDROM, DVD read only, DVD recordables, CDR, CDRW, etc.) inserted in the transmitting drive, in response to the first copying button activation; and a receiving optical disc drive in communication with the transmitting drive and having a second copying button, the receiving drive receiving the data transmitted from the transmitting drive and recording the received data on any recordable optical recording disc type (e.g., CDR, CDRW, DVD recordables, etc.) inserted in the receiving drive, in response to the second copying button activation. The transmitting and receiving drives are in direct communication with each other via wire or wirelessly, typically serially by wire.

While this invention has been particularly shown and described with reference to a few example embodiments thereof, it will be understood by those skilled in the art that various changes in form and details may be made therein without departing from the spirit and scope of the invention as defined by the appended claims and their equivalents.

What is claimed is:

1. An optical recording medium copying apparatus, comprising:
a transmitting optical recording medium drive in which a first optical recording medium is inserted, and which transmits data recorded on the inserted first optical recording medium when both a predetermined power and a copying signal are applied to the transmitting optical recording medium drive;
a receiving optical recording medium drive in which second optical recording medium is inserted, which receives the data from the transmitting optical recording medium drive when both a predetermined power and a copying signal are applied to the receiving optical recording medium drive, and which records the received data on the inserted second optical recording medium; and
communication lines between the transmitting and receiving optical recording medium drives used to transmit the data recorded on the first optical recording medium in the transmitting optical recording medium drive to the second optical recording medium in the receiving optical recording medium drive.

2. The apparatus of claim 1, wherein the communication lines serially transmit the data recorded on the first optical recording medium in the transmitting optical recording medium drive to the second optical recording medium in the receiving optical recording medium drive.

3. The apparatus of claim 1, wherein the transmitting optical recording medium drive comprises:
a disc type determination unit which determines a type of the first optical recording medium inserted into the transmitting optical recording medium drive;
a disc related information decoding unit which decodes disc related data recorded in a lead-in area of the first optical recording medium;
a decoding unit which decodes program area data recorded in a program area of the first optical recording medium; and
a controller controlling transmission of the decoded disc related data recorded in the lead-in area and the decoded program area data recorded in the program area of the first optical recording medium to the receiving optical recording medium drive, controlling transmission of a signal to the receiving optical recording medium drive, when a copying key is pressed, the copying key installed outside the transmitting optical recording medium drive, and controlling transmission of a signal to the receiving optical recording medium drive indicating a state of the transmitting optical recording medium drive.

4. The apparatus of claim 3, further comprising a storage unit that stores the decoded disc related data and the decode program area data output from both the disc related information decoding unit and the decoding unit, respectively.

5. The apparatus of claim 3, wherein the disc type determination unit determines whether the first optical recording medium type is a stamp, a recordable or a rewritable optical recording medium containing audio data, video data, or data in a predetermined format.

6. The apparatus of claim 3, wherein the disc related information decoding unit decodes starting and ending points of lead-in area data and a program memory area (PMA) of the lead-in area of the first optical recording medium to decode the disc related data of the first optical recording medium, when the first optical recording medium is a recordable optical recording medium or a rewritable optical recording medium, the decoded disc related data including identification of the first optical recording medium and track information.

7. The apparatus of claim 3, wherein the disc related information decoding unit decodes starting and ending points of data and a table of content (TOC) area of the lead-in area of the first optical recording medium to decode the disc related data, including TOC information, of the first optical recording medium, when the optical recording medium is a stamp optical recording medium.

8. The apparatus of claim 3, wherein the disc related information decoding unit decodes information indicating whether the program area data is recorded on the first optical recording medium in units of tracks, sessions, or optical recording media.

9. The apparatus of claim 3, wherein the data recorded on the first optical recording medium is audio data, and the decoding unit decodes a sub-code, a sub-Q value, and the audio data.

10. The apparatus of claim 3, wherein the data recorded on the first optical recording medium is video data, and the decoding unit decodes the video data and further checks whether an error has occurred in the decoded video data.

11. The apparatus of claim 3, wherein the data recorded on the first optical recording medium is in a predetermined format, and the decoding unit decodes the predetermined format data and further checks whether an error has occurred in the decoded predetermined format data.

12. The apparatus of claim 4, wherein the controller checks a capacity of the storage unit and discontinues storing the decoded disc related and program area data in the storage unit when the storage unit is full.

13. The apparatus of claim 4, wherein the controller controls transmission of the decoded program area data stored in the storage unit to the receiving optical recording medium drive in units of bytes.

14. The apparatus of claim 3, wherein the controller waits to receive a confirmation from the receiving optical recording medium drive when the transmitted decoded program area data amounts to a predetermined data block.

15. The apparatus of claim 14, wherein the transmission of the program area data is discontinued if the transmitting optical recording medium drive does not receive the confirmation.

16. The apparatus of claim 4, wherein the controller controls transmission of all decoded data stored in the storage unit to the receiving optical recording medium drive and sends a confirmation signal indicating termination of the data transmission to the receiving optical recording medium drive.

17. The apparatus of claim 1, wherein the receiving optical recording medium drive comprises:
a disc type determination unit which determines a type of the second optical recording medium on which the received data transmitted from the transmitting optical recording medium drive is recorded;
a storage unit which stores the received data transmitted from the transmitting optical recording medium drive;
a signal processor signal processing the received data stored in the storage unit to convert the received data into a recordable signal; and
a controller controlling sequential recording of the received converted data in a lead-in area, a program area, and a lead-out area of the second optical recording medium, and controlling transmission of a confirmation signal indicating a state of the receiving optical recording medium drive to the transmitting optical recording medium drive, when a copying key is pressed, the copying key installed outside the receiving optical recording medium drive.

18. The apparatus of claim 17, wherein the disc type determination unit informs the transmitting optical recording medium drive that the received data transmitted from the transmitting optical recording medium drive cannot be recorded on the second optical recording medium, when the type of the second inserted optical recording medium is determined to be an optical recording medium other than a recordable optical recording medium or a rewritable optical recording medium.

19. The apparatus of claim 17, wherein the disc type determination unit informs the transmitting optical recording medium drive that the received data transmitted from the transmitting optical recording medium drive cannot be recorded on the second optical recording medium, when the type of the second inserted optical recording medium is a stamp optical recording medium.

20. The apparatus of claim 17, wherein the disc type determination unit prepares the second inserted optical recording medium for the recording, when the second optical recording medium is an unused blank recordable optical recording disc or a used rewritable optical recording disc from which data has been erased.

21. The apparatus of claim 17, wherein the controller checks a capacity of the storage unit and controls recording of the received data on the second optical recording medium when a predetermined capacity of the storage unit occupied by the received data amounts to a predetermined level.

22. The apparatus of claim 17, wherein the controller uses the received converted data stored in the storage unit to generate a sub-code and a sub-Q value for a program memory area (PMA) of the lead-in area, and to control recording second optical recording medium related information, the generated PMA sub-code, and the generated PMA sub-Q value in the PMA, the second optical recording medium related information including an identification of the second optical recording medium and track information.

23. The apparatus of claim 22, wherein the controller further generates a sub-code and a sub-Q value for a TOC area of the lead-in area after completing the recording in the PMA, and controls recording the TOC information, the generated TOC sub-code, and the generated TOC sub-Q value in the TOC area.

24. The apparatus of claim 23, wherein the controller further generates a sub-code and a sub-Q value for a pre-gap area of a certain block after completing the recording in the TOC area, and controls recording of the generated pre-gap area sub-code and the generated pre-page area sub-Q value in the pre-gap area.

25. The apparatus of claim 17, wherein the controller generates a sub-code and sub-Q value for the lead-out area after completing the recording of received converted program area data in the program area, and controls recording of the generated lead-out area sub-code and the generated lead-out area sub-Q value in the lead-out area.

26. The apparatus of claim 25, wherein the controller transmits a confirmation signal indicating recording termination to the transmitting optical recording medium drive after completing the recording in the lead-out area.

27. A method of copying an optical recording medium in an optical recording medium copying apparatus in which a transmitting optical recording medium drive operates when a predetermined power is applied to the transmitting drive and a receiving optical recording medium drive operates when a predetermined power is applied to the receiving drive and transmits or receives data using a communication line which is different from a communication line used by the transmitting optical recording medium drive, the method comprising:
determining types of optical recording media when the optical recording media are inserted into the transmitting and receiving optical recording medium drives and a copying signal is input to both these drives;
converting in the transmitting optical recording drive data recorded in a lead-in area and data recorded in a program area of the transmitting optical recording medium, into data for transmitting, and transmitting the converted data to the receiving optical recording medium drive;
sequentially recording in the receiving optical recording medium drive received data transmitted by the transmitting optical recording medium drive in a lead-in area and a program area of the receiving optical recording medium, generating lead-out area data to be recorded in a lead-out area of the receiving optical recording medium, and recording the generated lead-out area data in the lead-out area.

28. The method of claim 27, wherein the transmitting and receiving optical recording medium drives serially exchange data via the communication lines between the transmitting and receiving drives.

29. The method of claim 27, wherein the determining of the types of the optical recording media comprises determining whether the transmitting optical recording medium is a stamp, recordable or rewritable optical recording medium containing audio data, video data, or data of a particular format.

30. The method of claim 27, wherein the determining of the types of the optical recording media comprises informing the transmitting optical recording medium drive that the converted data transmitted from the transmitting optical recording medium drive cannot be recorded on the receiving optical recording medium, if determined that the receiving optical recording medium is an optical recording medium type other than a recordable optical recording medium or a rewritable optical recording medium.

31. The method of claim 27, wherein the determining of the types of the optical recording media comprises informing the transmitting optical recording medium drive that the converted data transmitted from the transmitting optical recording medium drive cannot be recorded on the receiving optical recording medium, if determined that the receiving optical recording medium is a stamp optical recording medium type.

32. The method of claim 27, wherein the determining of the types of the optical recording media comprises preparing the receiving optical recoding media for the recording, if determined that the receiving optical recording medium is an unused blank recordable optical recording disc or a used rewritable optical recording disc from which data has been erased.

33. The method of claim 27, wherein the data conversion in the transmitting optical recording drive comprises:
decoding the data recorded in the lead-in area of the transmitting optical recording medium;
decoding the data recorded in the program area of the transmitting optical recording medium; and
transmitting the decoded data recorded in the lead-in area and the program area to the receiving optical recording medium drive.

34. The method of claim 33, wherein the decoding of the data in the lead-in area comprises detecting starting and ending points of lead-in area data and a program memory area (PMA) of the lead-in area and decoding an identification of the transmitting optical recording medium and track information based on the detecting, if the transmitting optical recording medium is a recordable optical recording medium or a rewritable optical recording medium.

35. The method of claim 33, wherein the decoding of the data in the lead-in area comprises detecting starting and ending points of table of content (TOC) data and a TOC area of the lead-in area, and decoding the TOC data based on the detecting, if the transmitting optical recording medium is a stamp optical recording medium.

36. The method of claim 33, wherein the decoding of the data in the lead-in area comprises decoding information indicating whether the program area data is recorded on the transmitting optical recording medium in units of tracks, units of sessions, or as a session of transmitting optical recording media.

37. The method of claim 33, wherein the decoding of the program area data comprises decoding a sub-code and a sub-Q value, if the transmitting optical recording medium contains audio data.

38. The method of claim 33, wherein if the transmitting optical recording medium contains video data, the decoding of the program area data comprises decoding the video data and checking whether an error has occurred in the decoded video data.

39. The method of claim 33, wherein if the transmitting optical recording medium contains data of a particular format, the decoding of the program area data comprises decoding the particular format data and checking whether an error has occurred in the decoded particular format data.

40. The method of claim 33, wherein the decoded data transmission comprises transmitting in units of bytes.

41. The method of claim 33, wherein the decoded data transmission comprises waiting to receive a confirmation signal from the receiving optical recording medium drive when the transmitted decoded data amounts to a predetermined data block.

42. The method of claim 41, wherein the decoded data transmission comprises stopping transmission of the decoded data, if the transmitting optical recording medium drive does not receive the confirmation signal.

43. The method of claim 33, wherein the decoded data transmission comprises transmitting a confirmation signal indicating termination of the decoded data transmission to the receiving optical recording medium drive after transmission of all decoded data.

44. The method of claim 27, wherein the recording in the receiving optical recording medium drive comprises:
generating a sub-code and a sub-Q value for a program memory area (PMA) of the lead-in area of the receiving optical recording medium using the received data;
recording identification of the transmitting optical recording medium, track information, the generated PMA sub-code, and the generated PMA sub-Q value in the PMA;
generating a sub-code and a sub-Q value for a TOC area of the lead-in area of the receiving optical recording medium using the received data;
recording TOC information, the generated TOC sub-code, and the generated TOC sub-Q value in the TOC area;
generating a sub-code and a sub-Q value for a pre-gap area having predetermined blocks on the receiving optical recording medium using the received data;
recording the generated pre-gap area sub-code and the generated pre-gap area sub-Q value in the pre-gap area;
detecting program area data recorded in a program area of the transmitting optical recording medium from the received data;
recording the detected program area data in the program area of the receiving optical recording medium;
generating a lead-out area sub-code and a lead-out sub-Q value for the lead-out area of the receiving optical recording medium; and
recording the generated lead-out sub-code and the generated lead-out sub-Q value in the lead-out area, after the recording of the program area data in the program area.

45. The method of claim 27, wherein the recording in the receiving optical recording medium drive comprises transmitting a confirmation signal indicating termination of the recording to the transmitting optical recording medium.

46. An optical recording medium copying device, comprising:
a transmitting optical disc drive having a first copying button and transmitting data recorded on any optical disc type inserted in the transmitting drive, in response to the copying button activation; and
a receiving optical disc drive in communication with the transmitting drive and having a second copying button, the receiving drive receiving the data transmitted from the transmitting drive and recording the received data on any recordable optical disc type inserted in the receiving drive, in response to the second copying button activation.

47. The device of claim 46, wherein the data transmitted from the transmitting device comprises disc related information including program area data recording information indicating program area data recording in units of tracks, session, optical recordable discs, or variable and fixed packets.

48. An optical recording medium copying device applying power to two compact disc rewritable (CDRW) drives and in response to a copying signal input at the CDRW drives, respectively, copying data recorded on an optical recording medium inserted into one of the CDRW drives to an optical recording medium inserted in the other CDRW drive, without a PC system and/or a recording application program.

49. A transmitting optical disc device to communicate with a receiving optical disc device that receives data transmitted from the transmitting optical disc device and recording the received data on any recordable optical disc type inserted in the receiving optical disc devic, the transmitting optical disc device comprising:
a transmitting copying button; and
a transmitting optical disc drive transmitting data recorded on any optical recording disc type inserted in the transmitting optical disc drive to the receiving optical disc device, in response to the transmitting copying button activation.

50. A receiving optical disc device to communicate with a transmitting optical disc device that transmits data recorded on any optical recording disc type inserted in the transmitting optical disc device, the receiving optical disc device, comprising:
a receiving copying button; and
a receiving optical disc drive receiving the data transmitted from the transmitting optical disc device and recording the received data on any recordable optical disc type inserted in the receiving optical disc drive.
